(19) United States
(12) Patent Application Publication
(10) Pub. No.: US 2013/0146823 A1
(43) Pub. Date: Jun. 13, 2013

(54) COMPRESSION KIT FOR INDEPENDENT SUSPENSION SYSTEM

(71) Applicant: Charles K. Hughes, JR., Summerville, SC (US)

(72) Inventor: Charles K. Hughes, JR., Summerville, SC (US)

(73) Assignee: Force Protection Industries, Inc.

(21) Appl. No.: 13/324,476

(22) Filed: Dec. 13, 2011

(51) Int. Cl. B25B 27/30

(52) U.S. Cl. 254/10.5

(57) ABSTRACT

A portable kit for compressing an elastic member in a suspension assembly of a vehicle includes a mounting bracket for attaching to an elastic member mount and having an insertion hole; an elongated member for inserting through the insertion hole and through an opening in a suspension control arm; a first affixing mechanism for securing the elongated member to the control arm; a mechanical cylinder for compressing the elastic member; and a second affixing mechanism for securing the mechanical cylinder to the elongated member. A hydraulic hand pump may also be included.

### BACKGROUND

1. Technical Field

This invention relates generally to a tooling kit for providing maintenance for vehicles using an independent suspension system, such as commercial or military vehicles. Specifically, the tooling kit is used to compress springs on the independent suspension system to allow assembly and disassembly of the vehicle axles.

2. Description of Related Art

Many spring compressor tools are known in the prior art for compressing suspension springs used on motor vehicles so that the spring can be removed and replaced during servicing of the vehicle's suspension system. The need for such tools has become even more important since more vehicles having independent suspensions are now in use. However, many of the prior art spring compressor tools are not capable of achieving sufficient compression of the spring while the spring is mounted on the vehicle. Further, present forms of spring compressors utilize elaborate and clumsy mechanisms and are very difficult to apply and utilize.

During repairs, when the axle is on the truck, servicers typically use a jack to push the spring against the truck weight in order to compress the spring. However, such a method is not safe. Alternatively, chains and hand hoists can also be used for compressing the spring. Again, such a method can be dangerous. Due to the inefficiencies and safety hazards of the above methods, it is often easier to replace the entire axle rather than compressing the spring to make repairs. However, removing an entire compromised axle from the truck and replacing the compromised axle with an entire new axle offline is costly and labor intensive.

Oshkosh Defense manufactures a Battle Damage and Repair (“BDAR”) kit for repairing axles on its TAK-4® independent suspension system. When a truck axle gets damaged, the entire axle must be removed. Oshkosh Defense uses a large spring compressor for compressing the springs on both the left and right axle cradle assemblies of the axle at the same time. AC power is used for the compression of the springs. If one side of the axle is damaged, the Oshkosh spring compressor must be modified because it is designed to compress both springs at the same time. The entire axle is then removed and replaced, with the good parts of the axle being salvaged and stored as spare parts for future use. The foregoing operation, however, is extremely time consuming and, as a consequence, is relatively expensive.

Accordingly, there is a need to overcome the above disadvantages. There is a need for a device, method, and system for rapidly making repairs without removing an entire axle from a vehicle in the event only one side is damaged, for working on left and right axle cradle assemblies of the vehicle independently, and for providing a portable, self contained repair kit which does not require power for operation so that it can be easily used, such as in a military theater.

### SUMMARY

The present invention meets these and other needs by providing an on-vehicle spring compression tool kit capable of removing a spring to allow its safe removal from a vehicle despite limited accessibility to bolts of an independent suspension axle.

In one aspect, the invention provides a portable kit for use in compression of an elastic member, such as a spring coil, in a suspension assembly of a vehicle, the suspension assembly including at least an elastic member mount and a control arm. The portable kit includes a mounting bracket for attaching to the elastic member mount, the mounting bracket including at least one insertion hole; an elongated member for inserting through the at least one insertion hole and through an opening in the control arm; and a first affixing mechanism for securing the elongated member to the control arm. A mechanical cylinder is included in this kit for applying a force to compress the elastic member, the mechanical cylinder being attached to the elongated member, and a second affixing mechanism is provided for securing the mechanical cylinder to the elongated member. Further, a hand pump may be provided for activating the mechanical cylinder to compress the elastic member.

In another aspect, the invention provides a method for compressing and removing an elastic member in a suspension assembly of a vehicle, the suspension assembly including at least an elastic member mount and a control arm. The method includes the steps of attaching a mounting bracket to the elastic member mount, the mounting bracket including at least one insertion hole; inserting an elongated member through the at least one insertion hole and through an opening in the control arm; securing the elongated member to the control arm with a first affixing mechanism; attaching a mechanical cylinder to the elongated member; securing the mechanical cylinder to the elongated member with a second affixing mechanism; and applying a force to the elastic member and compressing the elastic member. Further, the step of applying the force to the elastic member may include activating the mechanical cylinder using a hydraulic hand pump.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

The accompanying drawings which are incorporated in and constitute a part of this specification illustrate embodiments and serve to explain the principles of the disclosed device, method, and system.

### BRIEF DESCRIPTION OF THE DRAWINGS

FIG. 1 is a perspective view of an exemplary commercial or armored vehicle equipped with an independent suspension system of the present invention;

FIG. 2 is a schematic view of the independent suspension system;

FIG. 3 is a schematic view of a rear axle of the independent suspension system of FIG. 2 without the suspension spring; and

FIG. 4 is a schematic view of a compression tool kit.

It is to be understood that both the foregoing general description and the following detailed description are exemplary and explanatory only and are not restrictive of the scope of the invention as claimed.

### DESCRIPTION OF THE DISCLOSED EMBODIMENTS

Reference will now be made in detail to the preferred embodiments of the invention, examples of which are illustrated in the accompanying drawings. Wherever possible, the same reference numbers will be used throughout the drawings to refer to the same or like parts.

Independent Suspension System

Independent suspension system is a broad term for any vehicle suspension system that allows each wheel on the same axle to move vertically, i.e., reacting to a bump or cavity in the road, independently of each other. This is contrasted with a beam axle, a live axle, or a De Dion axle system in which the wheels are linked and movement on one side affects the wheel on the other side. Most modern vehicles have independent front suspension (IFS). Many vehicles also have an independent rear suspension (IRS). A fully independent suspension has an independent suspension on all wheels. Independent suspensions typically offer better ride quality and handling characteristics due to lower unsprung weight and the ability of each wheel to address the road undisturbed by activities of the other wheels on the vehicle.

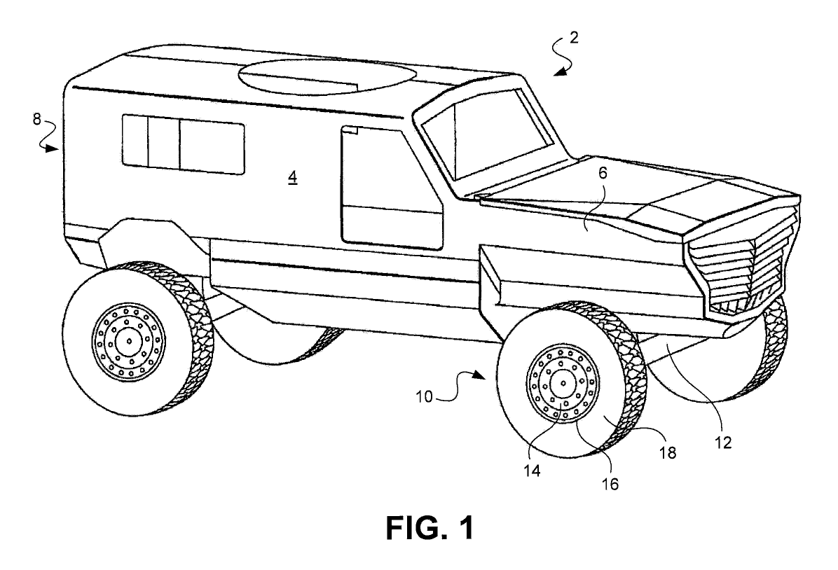

As broadly embodied in FIG. 1, a vehicle 2 may include a body 4 formed of sheet materials with a front end 6 and a rear end 8. The vehicle 2 may be a high performance vehicle such as, for example, a military vehicle. It is also contemplated that the vehicle 2 may be any other vehicle such as, for example, a construction vehicle or a commercial vehicle. The vehicle 2 may further include at least one wheel 10. While the embodiment depicted is a 4×4 (4 wheels total×4 wheels driven), the present invention is not limited thereto. The invention can be used in a 6×6 configuration, or any number or combination of driven and/or non-driven wheels. The invention may also be used for vehicles driven by a combination of wheels and tracks. Wheel 10 may be connected to vehicle 2 by an independent suspension axle 12.

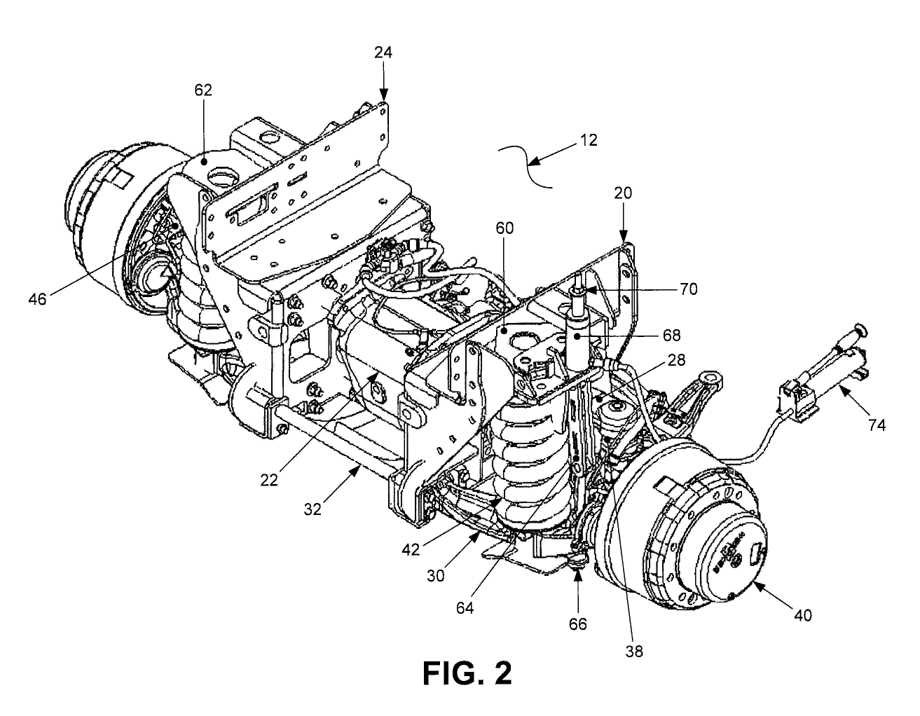

In the context of the present invention, wheel 10 may be suitable for any position on vehicle 2, such as for example, front, middle, or rear, or left or right, without limitation. Wheel 10 may include a mounting flange 14, a rim 16, and a tire 18. Mounting flange 14 may be configured to detachably fix wheel 10 to axle 12. Mounting flange 14 may include any known system for wheel mounting known in the art, such as, for example, one or more holes for accepting lug bolts. Rim 16 may be configured to seat tire 18. FIG. 2 depicts a more detailed view of axle 12.

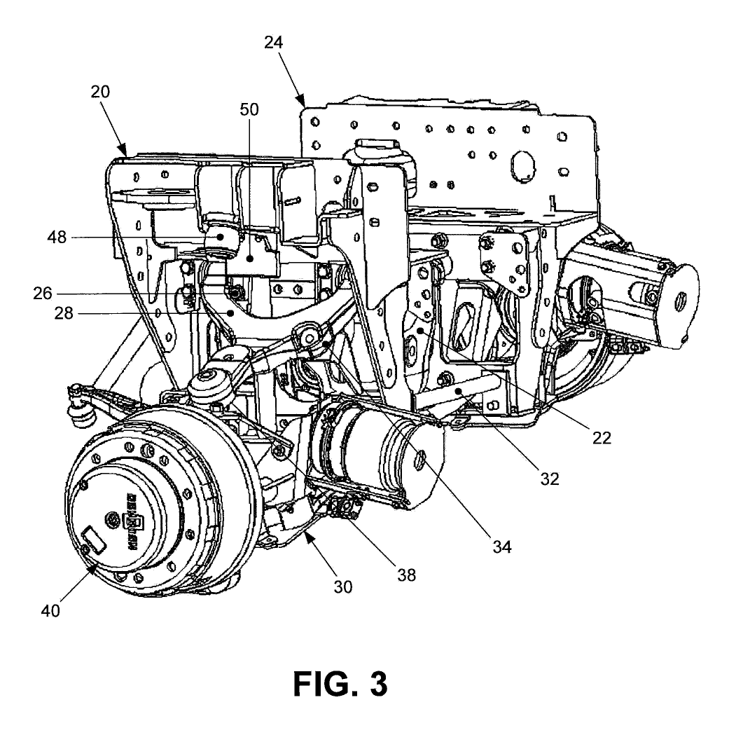

Referring to FIG. 2, the disclosed axle 12 can be segregated into four sections: a left cradle assembly 20, a differential housing 22, a right cradle assembly 24, and a skid plate assembly 32. In order to perform maintenance and repairs, the four sections 20, 22, 24, and 32 must be separated. The left and right cradle assemblies 20 and 24 are attached to the differential housing 22 by a series of bolts 26, as illustrated in FIG. 3. The bolts 26 must be removed on the skid plate assembly 32 before the differential housing 22 can be removed. Several of the bolts 26 attaching cradle assemblies 20 and 24 to differential housing 22 are located behind an upper control arm mounting assembly 28, which is more clearly visible in FIG. 3. The independent suspension assembly further includes a lower control arm mounting assembly 30, which is also depicted in FIGS. 2 and 3. Since the arrangements of the control arm mounting assemblies 28 and 30 in both left and right cradle assemblies 20 and 24 are identical, except being mirror images of one another from side to side on axle 12, only the left cradle assembly 20 will be further described hereinafter.

As illustrated in FIG. 3, the upper control arm mounting assembly 28 of the left cradle assembly 20 is generally Y-shaped. Each of the arms of the upper control arm mounting assembly 28 terminates in a control arm pivot. The outer end of the upper control arm mounting assembly 28 receives a unique two-piece ball joint 38. The ball joint 38 holds the upper control arm mounting assembly 28 onto an axle hub 40. The axle hub 40 is for mounting the wheel 10 of the vehicle 2.

The suspension components, including the upper control arm mounting assembly 28, may be moved out of the way to allow access to the previously inaccessible bolts 26 behind the upper control arm mounting assembly 28, thereby splitting the axle assembly into the four separate components: the left cradle assembly 20, the differential housing 22, the right cradle assembly 24, and the skid plate assembly 32. In order to disassemble the components of the suspension system, an elastic member, such as a heavy coil spring 42, must first be compressed. Compressing the spring 42 first allows removal of a lower bump stop, not visible as it is located behind element 34. Once the lower bump stop has been removed, the lower control arm mounting assembly 30, a spindle assembly 46, and the upper control arm mounting assembly 28 may be lowered to allow removal of the spring 42. The spindle assembly 46 is located behind and attached to the axle hub 40 and ties the upper and lower control arm mounting assemblies 28 and 30, giving a pivot point for the suspension assembly. As illustrated in FIG. 3, once the spring 42 has been removed, an upper bump stop 48 and an end-of-travel hard stop 50, which assists in terminating suspension travel, may also be removed. The upper bump stop 48 may consist of a rubber cushion, which in turn is secured to one of two triangular struts (not shown), which in turn are welded or otherwise suitably secured to the left or right cradle assemblies 20, 24. The upper bump stop 48 is positioned to engage the upper control arm mounting assembly 28 in the upward travel of the control arm.

After the upper bump stop 48 and the end-of-travel hard stop 50 are removed, the lower control arm mounting assembly 30, the spindle assembly 46, and the upper control arm mounting assembly 28 may be raised to allow access to the previously inaccessible bolts 26 that retain the differential housing 22. The previously inaccessible bolts 26 are located inside of the upper control arm mounting assembly 28, and are visible in FIG. 3 since the spring 42 has been removed and is no longer blocking the view.

Compression Tool Kit

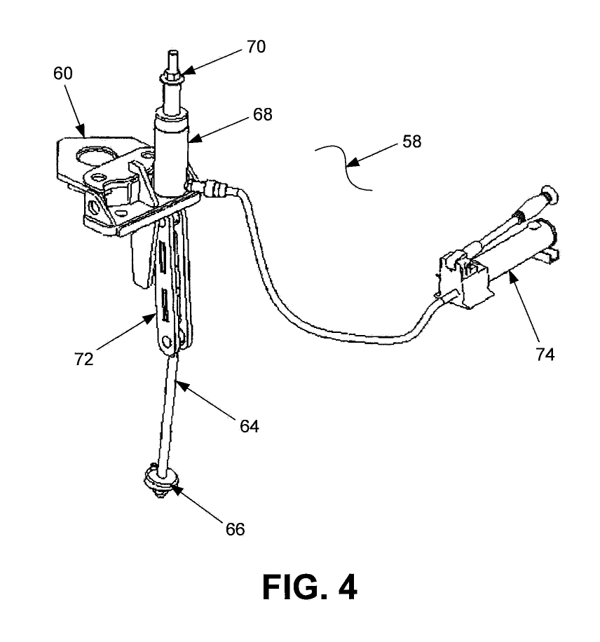

In general, in the present invention, a spring compression tool kit 58 provides a method for making repairs and performing maintenance on the vehicle's independent suspension system. The compression tool kit 58 allows a mechanic to remove the spring 42 when it is in an uncompressed or a free state. Referring to FIG. 4, a preferred on-vehicle spring compression tool kit 58 is shown in accordance with the present invention for compressing the heavy coil spring 42. The spring compression tool kit 58 is attached to an existing elastic member mount or spring mount 62 and the lower control arm mounting assembly 30 and draws them together to compress the spring 42 so that the lower bump stop can be removed. Once the lower bump stop is removed, the spring 42 is decompressed to a free state and can be safely removed from the axle.

The compression tool kit 58 includes a mounting bracket 60 supported and attached to the existing elastic member mount or spring mount 62, as illustrated in FIGS. 2 and 4. The mounting bracket 60 has a hollow boss that fits into an opening in the spring mount 62 and feet that rest on the spring mount 62. An elongated, high strength tension rod 64 is then threaded through an opening in the mounting bracket 60 and into an opening in the lower control arm mounting assembly 30. The high strength tension rod 64 is manufactured from a material having a tensile capacity of 36,000 lbs. Multiple segments of the tension rod 64 are coupled together using a double pivot frame 72, with the segments of the rod 64 being screwed into the frame. A washer and a nut, an angled adaptor, or other similar affixing mechanism 66 is provided on a bottom surface of the lower control arm mounting assembly 30 for securing the tension rod 64. A small mechanical cylinder 68, such as a hydraulic cylinder, may then be attached to the tension rod 64 with a nut and washer 70 or other similar affixing mechanism, which allows for adjustment of the hydraulic cylinder 68 on the tension rod 64. The hydraulic cylinder 68 is energized during removal of the lower bump stop. The hydraulic cylinder 68 is rated to apply a force of approximately 24,000 pounds. In this application, however, the compression tool kit 58 will only use sixty percent of the maximum rated load of the hydraulic cylinder 68.

Although the hydraulic cylinder 68 of the tool kit 58 may be activated by hydraulic pumps located on site, including electrically or pneumatically activated hydraulic pumps, the compression tool kit 58 may also preferably include a hydraulic hand pump 74, which is independent from an electrical source. The hydraulic hand pump 74 activates the hydraulic cylinder 68 for applying a force sufficient to compress the spring 42. The self contained compression tool kit 58 is portable and does not require power for operation so that it can be easily used in theater for rapidly making repairs to the axle 12 without removing the entire axle 12 from the vehicle 2 in the event only one side is damaged.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed method may be modified in any manner, including by reordering steps and/or inserting or deleting steps, without departing from the principles of the invention. It is intended, therefore, that the specification and examples be considered as exemplary only, with a true scope and spirit of the invention being indicated by the following claims and their full scope of equivalents.

What is claimed is:

1. A portable kit for use in compression of an elastic member in a suspension assembly of a vehicle, the suspension assembly including at least an elastic member mount and a control arm, the kit comprising:
a mounting bracket for attaching to the elastic member mount and including at least one insertion hole;
an elongated member for inserting through the at least one insertion hole and through an opening in the control arm;
a first affixing mechanism for securing the elongated member to the control arm;
a mechanical cylinder for applying a force to compress the elastic member, the mechanical cylinder being attached to the elongated member; and
a second affixing mechanism for securing the mechanical cylinder to the elongated member.

2. The kit of claim 1, wherein the mounting bracket includes a plurality of mounting brackets comprising a first mounting bracket for attaching to a front axle of the vehicle, and a second mounting bracket for attaching to a rear axle of the vehicle.

3. The kit of claim 1, further comprising:
a hand pump for activating the mechanical cylinder to compress the elastic member.

4. The kit of claim 1, wherein the elastic member is a heavy coil spring.

5. The kit of claim 1, wherein the elongated member is a high strength tension rod.

6. The kit of claim 3, wherein the hand pump is a pneumatic, electric, or hand powered hydraulic pump.

7. The kit of claim 1, wherein the mechanical cylinder is a hydraulic cylinder.

8. The kit of claim 5, wherein the high strength tension rod includes threads for threading the rod through the at least one insertion hole in the mounting bracket and the opening in the control arm.

9. The kit of claim 1, wherein the elongated member is threaded and the first affixing mechanism is a washer and a nut or an angled adaptor.

10. The kit of claim 1, wherein the elongated member is threaded and the second affixing mechanism is a washer and a nut.

11. The kit of claim 1, wherein the control arm includes an upper control arm and a lower control arm, the elongated member being inserted through the opening in the lower control arm.

12. The kit of claim 1, wherein the elongated member includes multiple segments coupled together with a pivot frame for adapting to elastic members having different angles.

13. A method for compressing an elastic member in a suspension assembly of a vehicle, the suspension assembly including at least an elastic member mount and a control arm, the method comprising the steps of:
attaching a mounting bracket to the elastic member mount, the mounting bracket including at least one insertion hole;
inserting an elongated member through the at least one insertion hole and through an opening in the control arm;
securing the elongated member to the control arm with a first affixing mechanism;
attaching a mechanical cylinder to the elongated member;
securing the mechanical cylinder to the elongated member with a second affixing mechanism; and
applying a force to the elastic member using the mechanical cylinder and compressing the elastic member.

14. The method of claim 13, wherein the step of applying the force to the elastic member comprises energizing the mechanical cylinder using a hydraulic pump.

15. The method of claim 13, wherein the step of inserting the elongated member includes threading the elongated member through the at least one insertion hole in the mounting bracket and the opening in the control arm.

16. The method of claim 13, wherein the step of applying the force to the elastic member using the mechanical cylinder includes activating a hydraulic cylinder.

17. The method of claim 14, wherein the step of applying the force to the elastic member includes activating a hydraulic pump.

18. The method of claim 13, wherein the step of inserting the elongated member through the opening in the control arm includes the control arm having an upper control arm and a lower control arm, and the elongated member being inserted through the opening in the lower control arm.

19. The method of claim 13, wherein the step of inserting the elongated member through the at least one insertion hole and through the opening in the control arm includes coupling together a plurality of segments of the elongated member with a frame for adapting to elastic members having different angles.
